(19) United States
(12) Patent Application Publication
(10) Pub. No.: US 2002/0049616 A1
(43) Pub. Date: Apr. 25, 2002

(54) INTERNET-AUDIOTEX ELECTRONIC ADVERTISING SYSTEM WITH DIRECT CONNECT

(76) Inventor: GREGORY J. SPEICHER, WORTHINGTON, OH (US)

Correspondence Address: WARD & OLIVO, 708 THIRD AVENUE, NEW YORK, NY, 10017

(21) Appl. No.: 08/881,096

(22) Filed: Jun. 24, 1997

Related U.S. Application Data
(63) Continuation-in-part of application No. 08/744,879, filed on Nov. 8, 1996.

(51) Int. Cl. G06F 17/60; H04L 12/66

(52) U.S. Cl. 705/4

(57) ABSTRACT

The present invention relates in general to an electronic advertising system. More specifically, the present invention provides a computer based direct connect system that is significantly more convenient and safer for the advertiser. In the present invention, when a person places a personal ad on the system, either via a telephone or via the Internet, the person inputs a telephone number that is stored in a database. Respondents can then direct connect and initiate a voice conversation by having the system call the advertiser's telephone number, whether the respondent's call initiates from a traditional telephone or from an Internet telephone. In addition, if the advertiser is on-line, respondents can direct connect and initiate a voice conversation with an advertiser, whether the respondent's call initiates from a traditional telephone or from an Internet telephone. If both the respondent and advertiser are on-line and both have a video capture device and camera, they can also have a video conference. These features greatly enhance the communications between the advertiser and the respondent while maintaining anonymity and heightening personal security.

### CROSS-REFERENCE TO RELATED APPLICATIONS

This application is a continuation-in-part of application Ser. No. 08/744,879, filed Nov. 8, 1996.

### TECHNICAL FIELD OF THE INVENTION

The present invention relates to audiotex systems designed to provide full access to traditional databases and telecommunications systems, such as local area networks, the Internet, other external databases, telephones, fax machines, classified ads, etc., and more specifically to audiotex and Internet personal ad services.

### BACKGROUND OF THE INVENTION

Audiotex personal ad services are a popular way for people to meet, and are available in most newspapers and on many cable television systems. In a typical service, an advertiser calls a live operator and places a text personal ad. An advertiser then calls an audiotex system and records an audio message, often referred to as a greeting, which expands upon the advertiser's text ad by describing in more detail the advertiser and the type of person he is seeking. Personal ads are then published in a newspaper. A personal ad typically includes a 900 telephone number and an ad mailbox number permitting a caller to listen to an advertiser's voice greeting. A caller can respond to an ad by recording a reply voice mail message for the advertiser. An advertiser retrieves a message by calling the audiotex system and entering a password given at the time of ad placement. In another format, live operators are not used. Instead, an advertiser first records an audio greeting via a telephone. An operator then listens to the audio greeting off-line and writes a text summary of the audio greeting for publication in the newspaper.

With the expansion of the Internet and other on-line services, personal ad services have been created to take advantage of this new medium. A typical service allows an advertiser to place a text personal ad that is published on the Internet on an HTML (HyperText Markup Language) page. An Internet user may respond to a personal ad by sending an advertiser a message via electronic mail. The limitation of this approach is that an Internet user cannot listen to an audio recording of an advertiser, a feature that is the central to audiotex personal ad services. Another limitation is that many people do not have Internet access, thus limiting the number of advertisers and respondents.

In another format, an attempt is made to integrate audiotex personal ads services with the Internet. Using this approach, personal ads are published in both the newspaper and on the Internet. Each personal ad includes a 900 telephone number and an ad mailbox number permitting a caller to listen to an advertiser's voice greeting. This approach still has the disadvantage of not allowing an Internet user to listen to an advertiser's voice greeting via the Internet. Moreover, an Internet user can only respond to a personal ad via a telephone because this approach does not allow Internet users to exchange messages with telephone users.

To summarize, existing Internet personal ad services are limited in that they lack many of the features available on audiotex personal ad services. Also, existing personal ad services do not provide a means for those using an audiotex personal ad service to effectively communicate with those using an Internet personal ad service and visa versa. Therefore, there is a need for a personal ad system that seamlessly integrates an audiotex system with an Internet server, allowing straightforward communication between those using a telephone and those using the Internet. Such a system has been proposed in detail by the present inventor which comprises application Ser. No. 08/744,879. However, there is still the need to address some of the problems and limitations inherent in an integrated audiotex and Internet based personal ad service.

Existing personal ad services allow a respondent to learn about an advertiser before leaving a message. In a typical audiotex-based personal ad service, the respondent reads a text ad published in the newspaper that gives basic information about the advertiser. This may include among other things the advertiser's age, race, brief description and a brief description of the person the advertiser is seeking. In addition to reading the text ad, a respondent can also call the audiotex system and hear an audio-recording of the advertiser. This audio recording typically complements the text ad by giving some additional information and allows the respondent to assess the advertiser based on speech qualities such as articulation and tone of voice. In spite of the usefulness of both the text ad and audio greeting, many users of personal ad services would like to actually speak with an advertiser before giving an advertiser their phone number or address. Similarly, many advertisers would like to be able to talk with respondents without giving out their telephone number. In this way, communication is greatly enhanced without giving up anonymity or compromising personal safety.

Such systems currently exist in some audiotex personal ad services. These services allow advertisers to give their telephone number at the time of ad placement which is, in turn, stored in a database. When another caller responds to the advertiser's personal ad, the respondent is given the option to direct connect to the advertiser. If the respondent selects the direct connect option, the respondent is put on hold and the audiotex system attempts to call the advertiser. If the audiotex system successfully reaches the advertiser, the respondent and the advertiser are bridged together and a conversation ensues. The call is made without the respondent knowing the advertiser's telephone number because the audiotex system makes the call to the advertiser using the advertiser's telephone number which is stored in a database.

The limitations of this approach become readily apparent when considered in the context of a personal ad service that fully integrates the Internet with audiotex/telephone-based personal ad services. Current systems do not allow an advertiser to place a personal ad via the Internet and then receive direct connect calls from respondents. Current systems do not allow a telephone respondent to direct connect to an advertiser who is on the Internet. Current systems do not allow a respondent who is on the Internet to direct connect to an advertiser's telephone. Current systems do not allow a respondent who is on the Internet to direct connect to an advertiser on the Internet.

The current invention greatly expands the communication options for users of personal ad services. With the current invention, an advertiser is able to place a personal ad either via telephone or via the Internet. At the time of ad placement, the advertiser inputs a telephone number that is stored in a database. Respondents can then direct connect and initiate a voice conversation by having the system call the advertiser's telephone number, whether the respondent's call initiates from a traditional telephone or from an Internet telephone. In addition, if the advertiser is on-line, respondents can direct connect and initiate a voice conversation with an advertiser, whether the respondent's call initiates from a traditional telephone or from an Internet telephone. Also, if a respondent and an advertiser both have a video camera connected to their computers, the respondent can direct connect to the advertiser and initiate a video conference. These features greatly enhance communication between advertiser and respondent while maintaining anonymity and heightening personal security.

### SUMMARY OF THE INVENTION

The present invention relates to an electronic advertising system. More specifically, the present invention provides a computer based direct connect system that is significantly more convenient and safer for the advertiser. In the present invention, when a person places a personal ad on the system, either via a telephone or via the Internet, the person inputs a telephone number that is stored in a database. Respondents can then direct connect and initiate a voice conversation by having the system call the advertiser's telephone number, whether the respondent's call initiates from a traditional telephone or from an Internet telephone. In addition, if the advertiser is on-line, respondents can direct connect and initiate a voice conversation with an advertiser, whether the respondent's call initiates from a traditional telephone or from an Internet telephone. In addition, if both the advertiser and respondent have video cameras connected to their computers, they can initiate a video conference. These features greatly enhance the communications between the advertiser and the respondent while maintaining anonymity and heightening personal security.

The significant advantages provided by the present invention are apparent from the above description. The present invention provides a more effective means of connecting individuals than previous systems. Also, the system of the present invention does not require the advertiser to divulge his or her telephone number to the public. In addition, new advertisers can meet someone faster because they are automatically connected with the chosen advertisers.

### BRIEF DESCRIPTION OF DRAWINGS

For a more complete understanding of the present invention, reference is made to the following drawings, in which:

FIG. 1 shows a schematic representation of the present invention.

FIG. 2 shows a table of the fields used for storing personal data, including a brief description of the particular fields.

FIG. 3 shows a table of the fields used for storing greeting data, including a brief description of the particular fields.

FIG. 4 shows a table of the fields used for storing response data, including a brief description of the particular fields.

FIG. 5 shows a flow diagram of an exemplary operation of the present invention, more specifically placing an advertisement through a telephone.

FIG. 6 shows a flow diagram of an exemplary operation of the present invention, more specifically placing an advertisement through the Internet.

FIG. 7 shows a flow diagram of an exemplary operation of the process of reviewing and summarizing advertisements as accomplished by the present invention.

FIG. 8 shows sample personal advertisements as they would appear in a local newspaper.

FIG. 9 shows a flow diagram of an exemplary operation of the process of responding to an advertisement through a telephone as accomplished without direct connect.

FIG. 10 shows a flow diagram of an exemplary operation of the process of responding to an advertisement through the Internet as accomplished without direct connect.

FIG. 11 shows a maximized personal advertisement as seen by the Internet user who chooses to expand the advertisement to full-page size.

FIG. 12 shows a flow diagram of the response confirmation process, including the Response Confirmation Form which gives the Internet user instructions on how to enhance a response to an advertisement with, audio, video or a photograph.

FIG. 13 shows a flow diagram of an exemplary operation of the process of retrieving responses through a telephone as accomplished by the present invention.

FIG. 14 shows a flow diagram of an exemplary operation of the process of retrieving responses through the Internet as accomplished by the present invention.

FIG. 15 shows a flow diagram of an exemplary operation of the process of responding to an advertisement through a telephone as accomplished by the present invention.

FIG. 16 shows a flow diagram of an exemplary operation of the process of responding to an advertisement through the Internet as accomplished by the present invention.

### DETAILED DESCRIPTION OF THE PREFERRED EMBODIMENT

As required, a detailed illustrative embodiment of the present invention is disclosed herein. However, telephone techniques, physical communication systems, data formats and operating structures in accordance with the present invention may be embodied in a wide variety of forms and modes, some of which may be quite different from those in the disclosed embodiment. Several of the components of the present invention are shown as separate systems. It should be understood that many of the subsystems, such as the Interactive Voice Response System and the Internet Gateway, could be combined into a single unit. Consequently, the specific structural and functional details disclosed herein are merely representative, yet in that regard, they are deemed to afford the best embodiment for purposes of disclosure and to provide a basis for the claims herein which define the scope of the present invention.

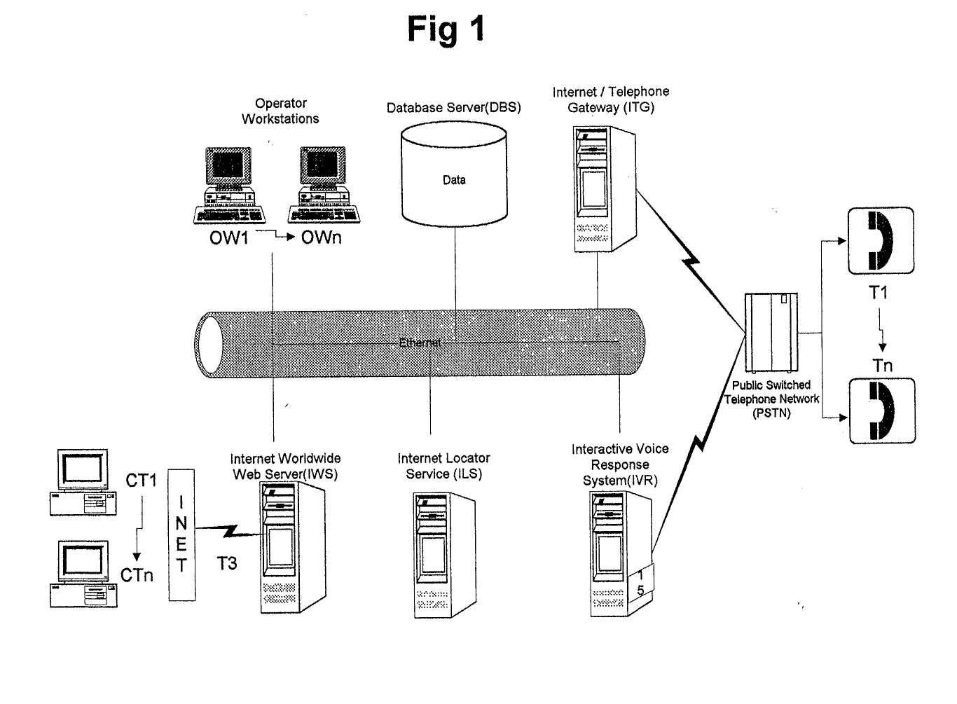

Referring initially to FIG. 1, a series of remote telephone terminals T1-Tn are represented. In addition, a series of remote computer terminals CT1-CTn are represented. The indicated terminals T1-Tn represent the multitude of telephone terminals existing in association with the public telephone network (PTN). The indicated computer terminals CT1-CTn represent the multitude of computer terminals connected to the Internet.

The PTN, which accommodates the individual terminals T1-Tn, is coupled to an Interactive Voice Response System (IVR). The Internet, which accommodates individual computer terminals CT1-CTn, is coupled to an Internet Web Server (IWS). Individual telephone callers use the individual telephone stations T1 through Tn to interface the IVR through the PTN. Individual users at computer terminals CT1 through CTn use the Internet to interface the IWS. Both telephone callers and Internet users may record digital audio messages that can be listened to from any of the remote telephone terminals T1-Tn or from any of the remote computer terminals CT1-CTn. Internet users may leave digital text messages that may be accessed from any of the remote telephone terminals T1-Tn using text to speech or from the remote computer terminals CT1-CTn via computer monitor.

First, considering the system of FIG. 1 in somewhat greater detail, it is to be understood that the PTN has multiplexing capability for individually coupling the terminals T1-Tn to the IVR on request. In the illustrative embodiment of the system, the individual terminals T1-Tn take the form of existing traditional or conventional telephone instruments. It is also to be understood that the Internet has the capability for individually connecting the computer terminals CT1-CTn to the IWS. In this illustrative embodiment of the system, the individual computer terminals CT1-CTn take the form of personal computers that comprise a central processing unit (CPU), modem, monitor, keyboard, hard drive, sound card, speakers and microphone. A certain number of CT1-CTn would also include a video capture card and a camera. In addition, the invention assumes that one or more of the individual computer terminals CT1-CTn is running Internet telephony client software, commercially available examples of which are Microsoft NetMeeting and Intel Internet Phone. To allow video conferencing, a given computer terminal would be loaded with Internet communication software that supports video, such ad Microsoft NetMeeting 2.0.

Second, considering the IVR in somewhat greater detail, the PTN is coupled to an IVR (see FIG. 1). In the disclosed embodiment, from the PTN, forty-eight lines are connected to the IVR from the PTN and, accordingly, the IVR may accommodate up to forty-eight simultaneous calls from the PTN. The IVR contains a processor, an exemplary form of which is an Intel 166 MHz Pentium Processor. The forty-eight lines from the PTN are connected to the processor though an interface 15, an exemplary form of which is a series of commercially available Dialogic (D240SC-T1) cards. The interface incorporates modems, tone decoders, switching mechanisms, DNIS and ANI capability. The Dialogic card stores audio information in the Dialogic .VOX format.

Generally, DNIS capability is a function of the PTN to provide digital data indicating the called number. ANI capability is a similar function whereby the digital data indicates the calling number.

Considering the IWS in somewhat greater detail, the IWS is coupled to the Internet via a T3 line to a local Internet provider service. The IWS may accommodate a multitude of simultaneous Internet users. As represented, the IWS is a micro computer programmed for Internet information server operations. The IWS contains a processor and Internet server software, exemplary forms of which are an Intel 166 Mhz Pentium Processor and Microsoft Internet Information Server software.

The IWS is also loaded with RealAudio Server software from Progressive Network. RealAudio allows a Microsoft Windows .WAV file to be converted into a RealAudio .RA file, a compressed format that allows playback over the Internet in real time, as opposed to first downloading a file and then listening to it. RealAudio accomplishes this by playing an audio file while it is still downloading, using a process called data streaming.

The IWS is also loaded with VDOLive Server software. VDOLive allows a video clip in the Microsoft Windows AVI, Apple Quicktime, or MPEG video files formats to be converted into a VDOLive .VDO format, a compressed format that allows playback over the Internet in real time, as opposed to first downloading a file and then listening to it. VDOLive also utilizes data streaming.

The IVR and the IWS are coupled to a Database Server (DBS) via an Ethernet hub as shown in FIG. 1. The system includes one or more Operator Workstations (OWS) OW1-OWn, through which an operator can interact with and control the DBS, IVR and IWS.

The DBS is a computer programmed for database operations. In the illustrated embodiment, the DBS manages a personal Ad Database which is comprised of multiple tables that manage ad creation, the audio greeting files, ad response files, photograph and video files and keyword searching of ads. The Ad Database comprises an electronic equivalent of the personal classified ads placed via telephone and the Internet, and responses placed to ads.

In addition, the DBS converts audio files received via telephone into the RealAudio .RA format for real time retrieval via the Internet. Conversely, the DBS converts audio files received via the Internet into Dialogic .VOX files for retrieval via telephone. Audio file conversions are done through audio file conversion software, an exemplary form of which is Sound Forge Studio by Sonic Foundry.

The DBS contains a processor and an SQL (Structured Query Language) relational database software, exemplary forms of which are the Intel 166 Mhz Pentium Processor and Microsoft SQL Server.

The Internet Locator Service (ILS) is coupled to the Internet and the other systems via an Ethernet connection. The ILS consists of a computer programmed to track the IP addresses of users who are on line at any given time. An exemplary form of such a system comprises an Intel 166 Mhz Pentium Processor, Microsoft NT 4.0 and Microsoft Internet Locator Service. The ILS facilitates users of a personal ad service in locating and connecting with each other using current real-time communication and collaboration tools. Such a connection requires the users to know each other's IP address. However, in many cases, this address is dynamically assigned each time a user logs onto the network and/or is not recognizable as a “friendly name”; hence, it is constantly changing or not recognizable. The ILS keeps track of dynamic user addresses, presents necessary connection information, and provides access to users of a personal ad service.

The Internet/Telephone Gateway (ITG) bridges the gap between the Public Switched Telephone Network (PSTN) and the Internet to enable calling from PC-to-telephone and telephone-to-PC. A commercially available ITG is Telephony Gateway by Vocaltec. The ITG consists of a DSP (Digital Signal Processing) or CPU, analog trunk interface jacks, a 100BaseT Ethernet transceiver, flash RAM (for DSP code), and RAM (for buffering data). The ITG digitizes audio from the PSTN interfaces, compresses and decompresses it, and transmits it over an Ethernet interface using the TCP/IP protocol.

The OWSs of the present invention can be conventional personal computers equipped with a sound card capable of playing the audio data and a video display capable of displaying digitally stored photographs and movies. An exemplary form of the OWS is a microcomputer equipped with an Intel 166 Mhz Pentium Processor and a Creative Labs Sound Blaster sound card. Operators review all incoming advertiser files—text, audio, photograph, and video—to insure that their content is appropriate. Also, operators use advertisers' text messages and audio recordings to create summary text ads for publication in a newspaper.

The following sections describe in greater detail the interaction between the IVR, DBS, IWS, ILS, ITG and OWS.

Placing an Ad Through a Telephone

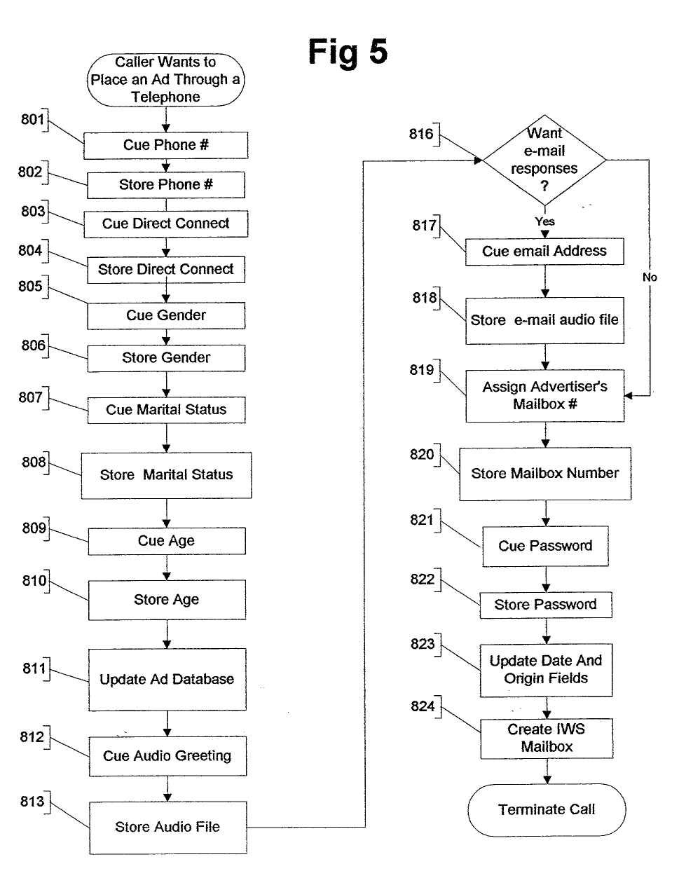

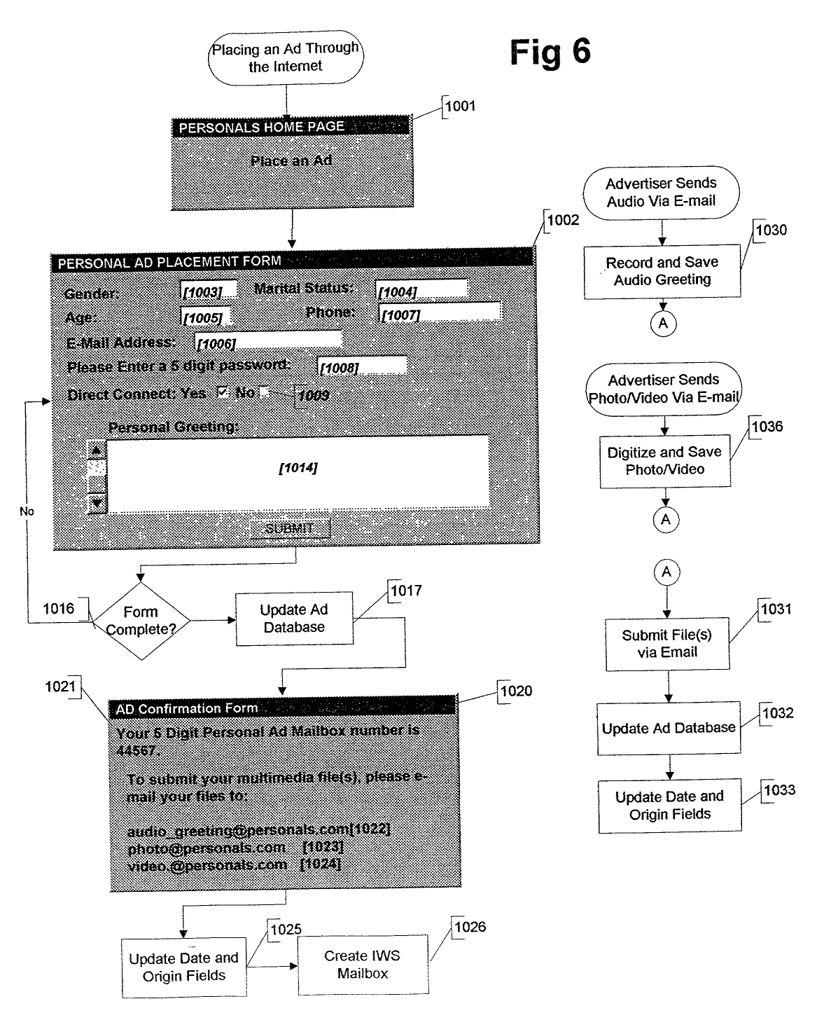

An exemplary operation of the system, with regard to a specific telephone caller placing a personal advertisement will now be treated to accomplish the process as indicated in FIG. 5. First, suppose a telephone caller at terminal T1 makes a call to place a personal advertisement in response to an advertisement in XYZ newspaper. The assumed call involves the telephone caller actuating the buttons to input the number 1-8-0-0-5-5-5-3-3-3-3, for example. As a result, signals are provided to the PTN resulting in a connection from the remote terminal T1 to the IVR. Using standard DNIS techniques, the IVR associates the called number 1-8-0-0-5-5-5-3-3-3-3 with a specific format, for example, a voice personals ad taking format.

The caller is first prompted to create a profile of himself by answering a series of questions using the buttons on his touch tone phone. Referring initially to FIG. 5, upon receiving a call, the IVR cues the caller to enter his telephone number 801. The IVR stores the telephone number 802 in the field AD PHONE 203. Next, the IVR asks the caller if he would like to enable the direct connect feature, thereby allowing respondents to be able to call the advertiser's telephone number, without revealing the number 803. For example: “If you would like to activate the direct connect feature, press 1. If you do not wish to activate the direct connect feature, press 2.” The IVR stores the caller's response 804 in the field AD_DIRECT_CONECT 212. Specifically, the direct connect feature allows an advertiser to actually speak with a respondent without having to give out his or her telephone number, thereby enhancing communication while maintaining anonymity. It may be desirable to ask the caller to indicate the time of day he would like the direct connect feature enabled. For example, some advertisers may only want to receive direct connect calls during certain hours when they are more likely to be at the telephone number given.

Next, the IVR cues the caller to enter his gender 805. For example: “If you are a woman, press 1. If you are a man, press 2.” The IVR stores the caller's gender 806 in the field AD_GENDER 207. Next, the IVR cues the caller for his marital status 807. For example: “If you are single, press 1. If you are divorced, press 2. If you are widowed, press 3.” The caller responds and the IVR stores the caller's marital status 808 in the field AD_MARITAL_STATUS 208. Next, the IVR cues the caller for his age 809. For example: “Please enter your age.” The caller's age is then stored 810 in the field AD_AGE 209.

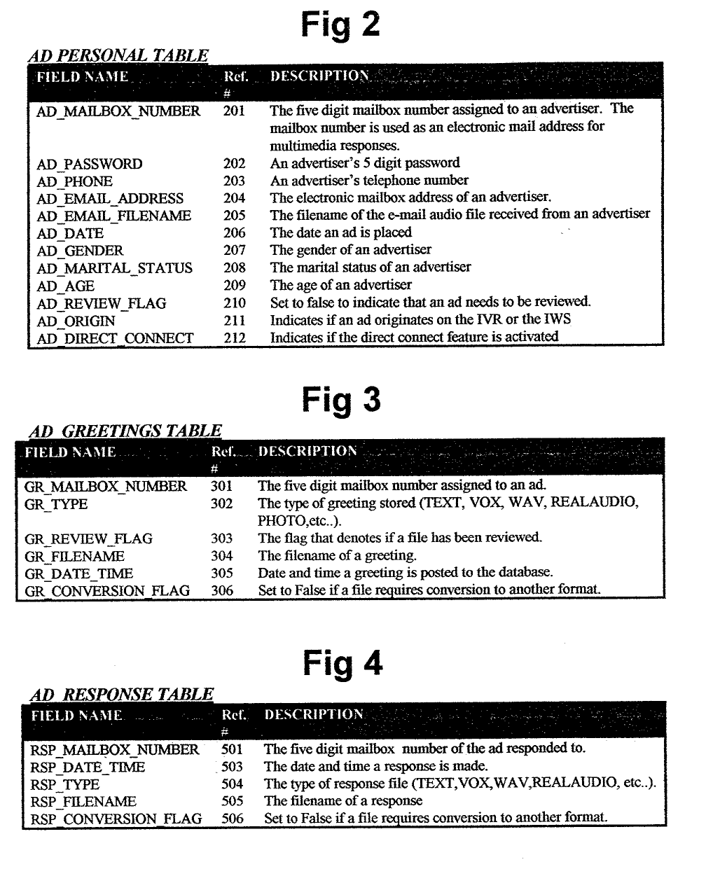

Next, the IVR cues the caller to record an audio greeting 812—. The advertiser's audio greeting is then stored to a disk file on the IVR 813 and Ad Database is updated 809. Specifically, the AD_REVIEW_FLAG 210 in the AD_PERSONAL_TABLE FIG. 2 is set to FALSE indicating that the ad must be reviewed by an operator. In addition, a new record is created in the AD_GREETINGS_TABLE FIG. 3 and the field GR_REVIEW_FLAG 303 set to FALSE to indicate that the audio greeting has not been reviewed. In the new record, the fields GR_MAILBOX_NUMBER 301, GR_TYPE 302, GR_FILENAME 304, GR_DATE_TIME 305 in the AD_GREETINGS_TABLE FIG. 3 are also populated to indicate the advertiser's mailbox number, the format of the audio file, the location of the audio file on the IVR and the date and time the greeting was recorded. The field GR_TYPE is set to VOX—to indicate that the audio recording is in the Dialogic .VOX file format. Finally, the field GR_CONVERSION_FLAG 306 is set to FALSE to indicate that the audio file must be converted from the Dialogic .VOX format to create a new audio file in the RealAudio .RA format for playback on the Internet.

The IVR then cues the caller to indicate if he wishes to record an e-mail address 816. For example: “Press 1 to input an e-mail address. Press 2 to decline.” If the caller elects to leave an e-mail address, the IVR cues the caller to record his e-mail address 817. The audio recording is stored to a disk file on the IVR 818 and the field AD_EMAIL_FILENAME 205 in table AD PERSONAL FIG. 2 is set, indicating that an e-mail audio file exists and its location on the IVR.

Next, the IVR assigns the advertiser a five digit mailbox number 819. For example: “Your 5-digit mailbox number is 12345.” The mailbox number is then stored 820 in the field AD_MAILBOX_NUMBER 201. The IVR then cues the caller to enter a five digit password 821. The password is stored 822 in the field AD_PASSWORD 202.

In addition, the IVR stores the date the ad is taken in the field AD_DATE_TIME 206, and updates the field AD_ORIGIN 211 to indicate that the personal ad originated on the telephone 823. Finally, the IVR creates an electronic mailbox for the advertiser on the IWS 824 and stores it in the field AD_MAILBOX_NUMBER 201 to allow respondents to submit audio, video and photographic files in response to the advertiser's ad.

Placing an Ad Through the Internet

An exemplary operation of the system, with regard to a specific Internet user placing a personal advertisement will now be treated to accomplish the process as indicated in FIG. 6. First, suppose an Internet user at terminal CT1 connects to the Internet to place a personal advertisement in response to an advertisement in XYZ newspaper. The assumed Internet user connects to the Internet and inputs a Uniform Reference Locator (URL), for example: http://www.personal_ads.com, resulting in a connection from the remote terminal CT1 to a Home Page 1001 on the IWS.

Referring to FIG. 6, from the Home Page 1001 on the IWS, the Internet user selects an Ad Placement Form 1002. The Ad Placement Form 1002 contains the following input fields corresponding to fields in the Ad Database as indicated:

| | |
|---|---|
| Gender 1003 | AD_GENDER 207 |
| Marital Status 1004 | AD_MARITAL_STATUS 208 |
| Age 1005 | AD_AGE 209 |
| E-mail address 1006 | AD_EMAIL_ADDRESS 204 |
| Phone Number 1007 | AD_PHONE 203 |
| Password 1008 | AD_PASSWORD 202 |
| Greeting Text 1014 | GR_FILENAME 304 |
| Direct Connect 1009 | AD_DIRECT_CONNECT 212 |

This process largely parallels the process of placing a personal ad via a telephone. The password 1008 is used by the advertiser to retrieve messages and the e-mail address 1006 and telephone number 1007 are used to contact the advertiser. The gender 1003, age 1005, and marital status 1004 fields create a profile of the advertiser. The Direct Connect button allows the advertiser to indicate if the she wants to allow respondents to “direct connect” to the telephone number given without revealing her telephone to the respondent 1009. As previously indicated, the Direct Connect feature allows an advertiser to actually speak with a respondent without having to reveal the advertiser's telephone number, thereby enhancing communication while maintaining anonymity. As previously discussed, it may be desirable to allow the advertiser to indicate the time of day she would like to enable the direct connect feature. Finally, the field Greeting Text 1014 describes the advertiser and the person she is seeking.

The Internet user completes the Ad Placement Form 1002 and presses the “Submit” button to submit her ad. The form is checked by the IWS for completeness 1016. If the form is incomplete, the user is returned to the Ad Placement Form 1002. If the form is complete, the IWS updates the Ad Database 1017. This includes assigning the user a five digit mailbox number and storing it in the field AD_MAILBOX_NUMBER 201. In addition, the advertiser's profile, contact information, password and greeting are added to the Ad Database. Also, the advertiser's text greeting is stored to a disk file on the IWS. Next, the AD_REVIEW_FLAG 210 in the AD_PERSONAL_TABLE FIG. 2 is set to FALSE indicating that the ad must be reviewed by an operator 10, a new record is created in the AD_GREETINGS_TABLE FIG. 3, and the field GR_REVIEW_FLAG 303 is set to FALSE to indicate that the text greeting has not been reviewed. In the new record, the fields GR_MAILBOX_NUMBER 301, GR_TYPE 302, GR_FILENAME 304, GR_DATE_TIME 305 in the AD_GREETINGS TABLE FIG. 3 are also populated to indicate the advertiser's mailbox number, the file format, the location of the text file on the IWS, and the date and time the greeting was placed. Specifically, the field GR_TYPE is set to TEXT. Finally, the field GR_CONVERSION_FLAG 306 is set to TRUE to indicate that the text does not need to be converted to a different format.

Next, the IWS then creates an Ad Confirmation Page 1020. The Ad Confirmation Page 1020 assigns the advertiser's mailbox number 1021, and gives the advertiser an e-mail address to submit an audio greeting 1022, photograph 1023, or video clip 1024 for inclusion with her personal ad. Also, the IWS stores the date and time the ad is taken in the field AD_DATE_TIME 206, and updates the field AD_ORIGIN 211 to indicate that the personal ad originated on the Internet 1025. Finally, the IWS creates an electronic mailbox for the advertiser 1026, using the mailbox number stored in the field AD_MAILBOX_NUMBER as the electronic mail address, to allow respondents to submit audio, video and photographic files in response to the advertiser's ad.

Enhancing an Internet Ad with Audio, Photograph and Video

A more detailed explanation of how an advertiser submits an audio greeting, photograph, or video clip via CT1 will now be given. To submit an audio greeting, the advertiser first makes an audio recording using a WAV file editor and then saves the file using her five digit mailbox number as the file name 1030 FIG. 6, for example: 44567.wav. The advertiser then submits the audio file using e-mail to an audio greeting electronic mailbox 1031, for example: audio_greeting@personals.com. The advertiser's audio recording is stored to a disk file on the IWS.

In addition, a new record is created in the AD_GREETINGS_TABLE FIG. 3 and the Ad Database is updated 1032. Specifically, the field GR_REVIEW_FLAG 303 is set to FALSE t indicate that the audio greeting has not been reviewed. Also, the fields GR_MAILBOX_NUMBER 301, GR_TYPE 302, GR_FILENAME 304, GR_DATE_TIME 305 in the AD_GREETINGS_TABLE FIG. 3 are also populated to indicate the advertiser's mailbox number, the format of the audio file, and the location of the audio file on the IWS, and the date and time the greeting was placed. The field GR_TYPE is set to WAV to indicate that the audio recording is in the Microsoft .WAV file format. Finally, the field GR_CONVERSION_FLAG 306 is set to FALSE to indicate that the audio file must be converted from the Microsoft .WAV format to create two new audio files: one in the RealAudio .RA format for playback on the Internet, and another in the Dialogic .VOX format for playback via the telephone.

To enhance a personal ad with a photograph, the advertiser first digitizes a photograph using a scanner or takes a photograph with a digital camera and then saves the image to a .GIF file using her five digit mailbox number as the file name 1036, for example: 44567.gif. The advertiser then submits the graphic file using e-mail to a photograph electronic mailbox, for example: photo@personals.com 1031.

The advertiser's photo is stored to a disk file on the IWS and the Ad Database is updated 1032. Specifically, a new record is created in the AD_GREETINGS_TABLE FIG. 3 and the field GR_REVIEW_FLAG 303 set to FALSE to indicate that the graphic file has not been reviewed. In each new record, the fields GR_MAILBOX_NUMBER 301, GR_TYPE 302, GR_FILENAME 304, GR_DATE_TIME 305 in the AD_GREETINGS_TABLE FIG. 3 are also populated to indicate the advertiser's mailbox number, the format of the graphic file, the location of the graphic file on the IWS, and the date and time the photograph was received. The field GR_TYPE 302 is set to GIF to indicate that the graphic file is in the .GIF file format. Finally, the field GR CONVERSION_FLAG 306 is set to TRUE to indicate that no file conversion is necessary as .GIF is the graphic file format used by the IWS. If other graphic formats were accepted, they might have to be converted to a .GIF format, depending on the file formats supported by the IWS. If file conversion were necessary, the field GR_CONVERSION_FLAG 306 would be set to FALSE.

To enhance a personal ad with video, the advertiser first digitizes a video clip and then saves the image to a Microsoft .AVI file using her five digit mailbox number as the file name 1036, for example: 44567.avi. Other video formats such as Apple Quicktime, or MPEG video could also be used. The advertiser then submits the graphic file using e-mail to an electronic mailbox, for example: video@personals.com 1031.

The advertiser's video clip is stored to a disk file on the IWS and the Ad Database is updated 1032. Specifically, a new record is created in the AD_GREETINGS_TABLE FIG. 3 and the field GR_REVIEW_FLAG 303 set to FALSE to indicate that the video file has not been reviewed. In each new record, the fields GR_MAILBOX_NUMBER 301, GR_TYPE 302, GR_FILENAME 304, GR_DATE_TIME 305 in the AD_GREETINGS_TABLE FIG. 3 are populated to indicate the advertiser's mailbox number, the format of the video file, the location of the video file on the IWS, and the date and time the video was received. Specifically, the field GR_TYPE 302 is set to AVI to indicate that the video clip is in the Microsoft .AVI file format. Finally, the field GR_CONVERSION_FLAG 306 is set to FALSE to indicate that the video file must be converted to the VDOLive format for real time playback on the Internet.

Reviewing and Summarizing Ads

All new personal ads are reviewed by an operator at an OWS OW1 to insure that their content is appropriate. Also, each greeting submitted by an advertiser, whether it be an audio greeting recorded by an advertiser via a telephone or a text greeting placed by an advertiser via the Internet, is summarized by an operator to create a twenty word classified text ad for publication in a newspaper. The twenty word limit is a function of newspaper imposed space limitations. It should be noted that space limitations, if they exist at all, may vary widely from newspaper to newspaper. In another format, text ads that are published in the newspaper are first placed with a live operator via a telephone, precluding the need to summarize an audio recording.

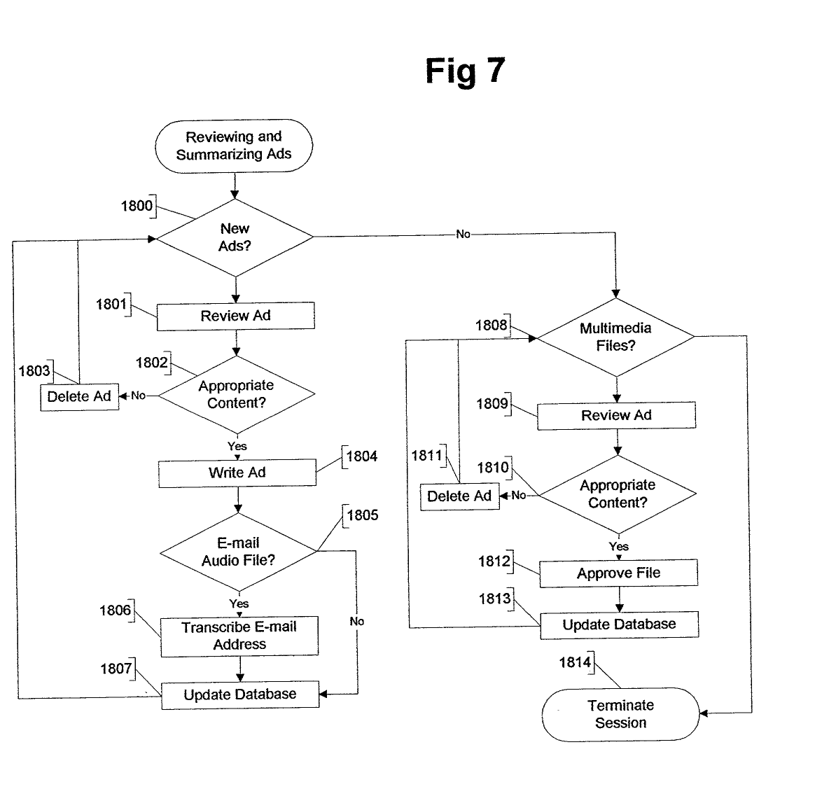

An exemplary operation of the process of reviewing and summarizing ads with regard to a specific operator at OP1 will now be treated to accomplish the process as indicated in FIG. 7. The operator first queries the Ad Database to determine if there are new ads to review 1800. Specifically, the query looks for all ads in the AD_PERSONAL_TABLE FIG. 2 where the field AD_REVIEW_FLAG 210 is set to FALSE. If the query finds a new ad, the operator first reviews the ad's greeting 1801 as found in the AD_GREETINGS_TABLE FIG. 3. If the ad was placed via telephone, this consists of listening to the ad's audio greeting. If the ad was placed via the Internet, this consists of reading the text greeting. The operator then determines if the greeting's contents are appropriate 1802. If the greeting's contents are inappropriate, the ad is deleted and the record purged from the database 1803 and the operator is returned to block 1800. If the greeting's contents are appropriate, the operator writes a twenty word summary of the greeting 1804. The operator then queries the database to determine if the advertiser recorded an e-mail address 1805. If an e-mail address audio recording is found, the operator transcribes the e-mail address 1806. The operator then updates the Ad Database 1807.

Specifically, the advertiser's twenty word text summary is stored to a disk file on the IWS. The AD_REVIEW_FLAG 210 in the AD_PERSONAL TABLE FIG. 2 is set to TRUE indicating that the ad has been reviewed. In addition, a new record for the text summary is created in the AD_GREETINGS_TABLE FIG. 3 and the field GR_REVIEW_FLAG 303 set to TRUE indicating that the record has been reviewed. In the new record, the fields GR_MAILBOX_NUMBER 301, GR_TYPE 302, GR_FILENAME 304, GR_DATE_TIME 305 in the AD_GREETINGS_TABLE FIG. 3 are also populated to indicate the advertiser's mailbox number, the file format, the location of the text file on the IWS, and the date and time. The field GR_TYPE is set to TEXT. Finally, the field GR_CONVERSION_FLAG 306 is set to TRUE to indicate that the text does not need to be converted to a different format.

The operator then returns to block 1800 to continue processing ads. If no new ads are found, the operator queries the database to determine if any multimedia files (audio, video, or photo) have been submitted via the Internet to enhance a personal ad 1808. Specifically, the query looks for all ads in the AD_PERSONAL_TABLE FIG. 2 where the field AD_REVIEW_FLAG 210 is set to TRUE that has files in the AD_GREETING_TABLE FIG. 3 where the GR_REVIEW_FLAG 303 is set to FALSE. If the query finds a multimedia file, the operator first reviews the file 1809. If it is an audio file, reviewing it consists of listening to the ad's audio greeting. If it is a video or graphic file, reviewing it consists of viewing the file. The operator then determines if the greeting's contents are appropriate 1810. If the greeting's contents are inappropriate, the filed is deleted and the record purged from the Ad Database 1811. The operator is then returned to block 1808 to continue processing multimedia files. If the file's contents are appropriate, the operator approves the file 1812 and updates the Ad Database 1813. Specifically, this consists of setting the field GR_REVIEW_FLAG 303 to TRUE to indicate that the file has been reviewed.

If the file is an audio file, the OWS converts the file to create a new RealAudio RA file and stores the file on the IWS. The OWS also converts the file to create a Dialogic VOX file and stores the file on the IVR. For each new audio file, a new record is created in the AD_GREETINGS_TABLE FIG. 2 and the fields GR_MAILBOX_NUMBER 301, GR_TYPE 302, GR_DATE_TIME 305, and GR_FILENAME 304 are populated to indicate the mailbox number of the advertiser, the format of the file, the date and time, and the location of the audio file on the IVR. Also, the field GR_REVIEW_FLAG 303 is set to TRUE to indicate that the file has been reviewed. Finally, the field GR_CONVERSION_FLAG is set to TRUE to indicate that the audio file does not need to be converted.

If the file is a video file, the OWS OW1 converts the Microsoft AVI file to create a new VDOLive file and stores the file on the IWS. Also, a new record is created in the AD_GREETINGS_TABLE FIG. 2 and the fields GR_MAILBOX_NUMBER 301, GR_TYPE 302, GR_DATE_TIME 305, and GR_FILENAME 304 are populated to indicate the mailbox number of the advertiser, the format of the file, the date and time, and the location of the video file on the IVR. Also, the field GR_REVIEW_FLAG 303 is set to TRUE to indicate that the file has been reviewed. Finally, the field GR_CONVERSION_FLAG 306 is set to TRUE to indicate that the video file does not need to be converted.

The operator then returns to block 1808 to continue processing multimedia files. If no new multimedia files are found, the session is terminated 1814.

Publishing Ads in the Newspaper

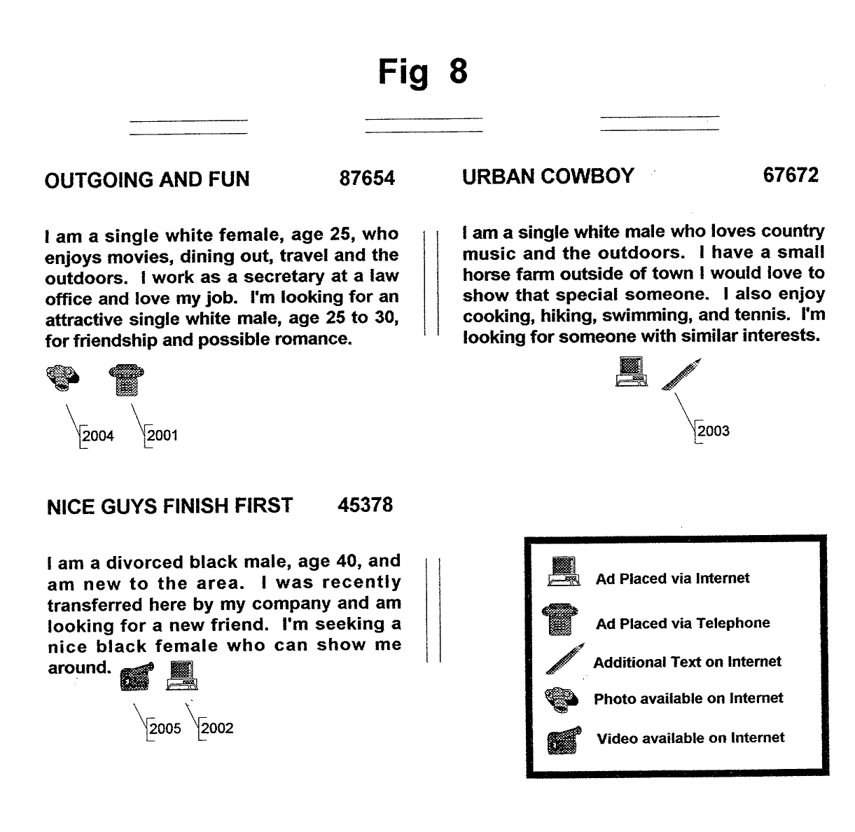

Each week, all the twenty-word summary text ads from personal ads submitted via telephone and via the Internet are published in a newspaper along with their five digit mailbox numbers. FIG. 8 depicts personal ads as they would appear in the local newspaper. Icons are included in each ad that represent the origin of an ad (via telephone or via the Internet) and what additional information or multimedia, if any, is available on the Internet. For example, an ad placed via the telephone contains a telephone icon 2001; an ad placed via the Internet contains a computer icon 2002. If there is additional text on the Internet, an ad contains an icon denoting additional text 2004. The presence of a photo or video clip is indicated respectively by a still camera 2004 and video camera 2005 icons.

Registering with the Internet Locator Service (ILS)

If an advertiser wishes to be directly contacted via the Internet by another user of the personal ad service, the advertiser must establish a connection to the Internet and also launch Internet telephony software, a commercial example of which is Microsoft NetMeeting. The advertiser must then go to the personal ad service and log in. By doing so, the advertiser's IP address will be registered with the ILS and the system will be “aware” that the advertiser is on line and available to respondents. Depending on the Internet telephony software used, it may not be necessary to actually log in at the personal ad service site. By simply setting the default settings to point to the ILS of the personal ad service, the advertiser is automatically registered when he establishes an Internet connection and launches the Internet telephony software.

Responding to an Ad Through a Telephone

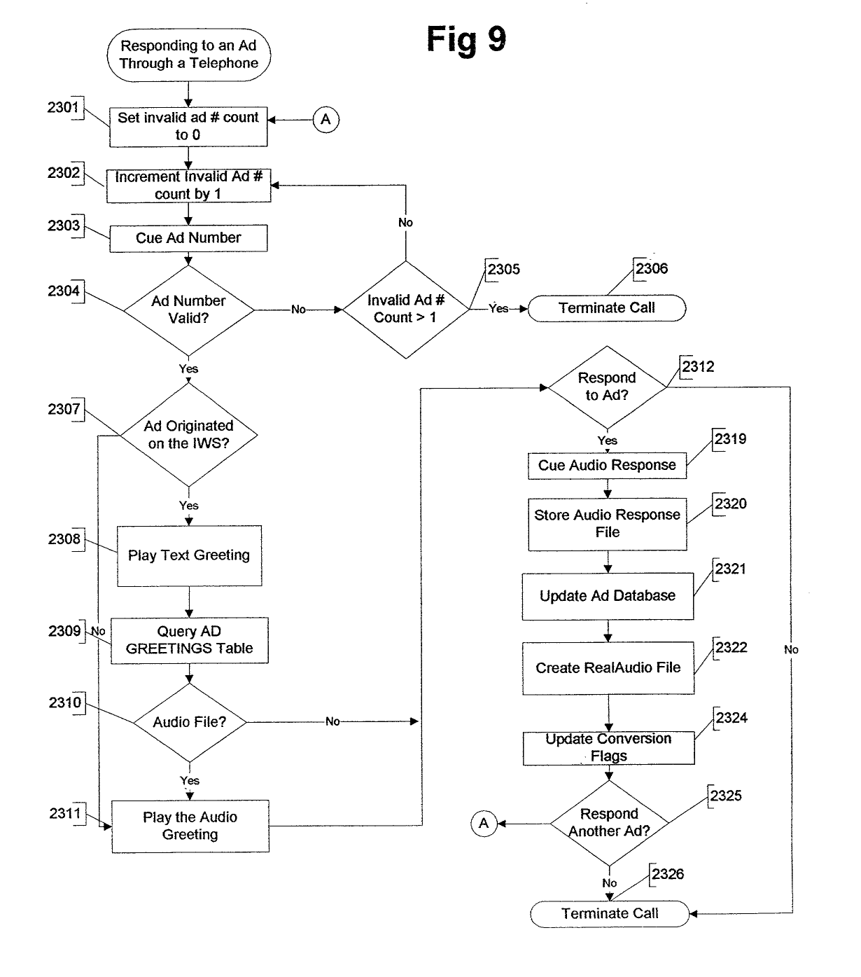

An exemplary operation of the system, with regard to a telephone caller responding to a personal advertisement will now be treated to accomplish the process as indicated in FIG. 9. First, suppose a telephone caller at terminal T1 places a call to respond to a personal ad advertised in XYZ newspaper. The assumed call involves the telephone caller actuating the buttons to input the number 1-9-0-0-7-7-7-3-3-3-3, for example. As a result, signals are provided to the PTN resulting in a connection from the remote terminal Tl to the IVR. Using standard DNIS techniques, the IVR associates the called number 1-9-0-0-7-7-7-3-3-3-3 with a specific format, for example, a voice personals response format.

Referring to FIG. 9, upon receiving a call, the IVR sets the “invalid mailbox number count” equal to zero 2301. The IVR then increments the “invalid mailbox number count” by one 2302 and cues the caller for a mailbox number 2303. Upon the caller entering a mailbox number, the IVR queries the field AD_MAILBOX_NUMBER 201 to determine if the mailbox number is valid 2304. If the mailbox number is invalid, the IVR determines if the caller has exceeded the maximum number of attempts allowed 2305. If the caller has exceeded the maximum number of attempts allowed, the call is terminated 2306. If the maximum number of attempts allowed has not been exceeded, the IVR increments the “invalid mailbox number count” by one 2302 and again cues the caller for a mailbox number 2303.

If the mailbox number is valid, the IVR queries the field AD_ORIGIN 211 to determine if the ad originated on the Internet 2307. If the ad originated on the telephone, the IVR plays the ad's audio greeting 2311. If the ad originated on the Internet, the IVR uses text-to-speech to play the ad's text greeting as placed on the Internet 2308. The IVR then queries the AD_GREETINGS_TABLE FIG. 2 to determine if the Internet advertiser also submitted an audio greeting 2309. If the query does not find an audio greeting 2310, the IVR prompts the caller to indicate if he wishes to respond to the ad 2312. If the query finds an audio greeting 2310, the IVR plays the audio greeting 2311. The IVR then prompts the caller to indicate if he wishes to respond to the ad 2312.

If the caller elects not to respond to the ad, he is then prompted to respond to another ad 2325. If the caller chooses to respond to another ad, the IVR continues processing at block 2301, otherwise the call is terminated 2326. If the caller elects to respond to the ad, the IVR cues the caller to record his response 2319. The IVR then stores the response to a disk file and updates the Ad Database 2321. Specifically, the IVR creates a new record in the AD_RESPONSE_TABLE FIG. 5 populates the fields RSP_MAILBOX_NUMBER 501, RSP_RMAILBOX_NUMBER 502, RSP_DATE_TIME 503, RSP_TYPE 504, and RSP_FILENAME 505 to indicate the mailbox number of the ad responded to, the mailbox number of the respondent, the date and time of the response, the format of the response, and the location of the response file on the IVR. The field RSP_TYPE 504 is set to VOX to indicate that the audio recording is in the Dialogic .VOX file format. Finally, the field RSP CONVERSION_FLAG 506 is set to FALSE to indicate that the audio must be converted from the Dialogic .VOX format to create a new audio file in the RealAudio .RA format for playback on the Internet.

The IVR also creates a new RealAudio .RA file from Dialogic .VOX file and stores the RealAudio file to a disk file on the IWS 2322. Specifically, the IVR creates a new record in the AD_RESPONSE_TABLE FIG. 5 and populates the fields RSP_MAILBOX_NUMBER 501, RSP_RMAILBOX_NUMBER 502, RSP_DATE_TIME 503, RSP_TYPE 504, and RSP_FILENAME 505 to indicate the mailbox number of the ad responded to, the mailbox number of the respondent, the date and time of the response, the format of the response, and the location of the response file on the IVR. The field RSP_TYPE 504 is set to RA to indicate that the audio recording is in the RealAudio .RA file format. Finally, the field RSP_CONVERSION_FLAG 506 is set to TRUE for both the audiotex .VOX file and the RealAudio .RA file to indicate that the audio files do not need to be converted 2324.

Responding to an Ad Through the Internet

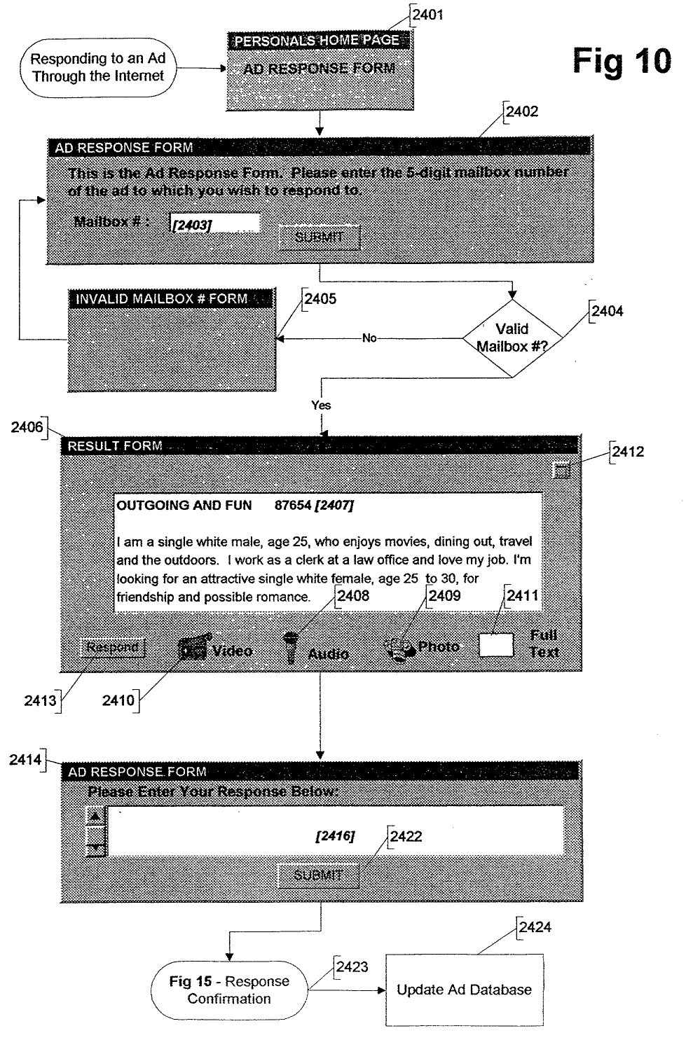

An exemplary operation of the system, with regard to a specific Internet user responding to a personal ad via the Internet will now be treated to accomplish the process as indicated in FIG. 10. First, suppose an advertiser at terminal CT1 connects to the Internet to respond to a personal advertisement advertised in XYZ newspaper. The assumed Internet user connects to the Internet and inputs a Uniform Reference Locator URL, for example: http://www.personal_ads.com, resulting in a connection from the remote terminal CT1 to a Home Page on the IWS.

Referring to FIG. 10, from the Home Page 2401 on the IWS, the Internet user selects an Ad Response Form 2402. The Ad Response Form instructs the Internet user to enter the five digit mailbox number of the ad she wishes to respond to 2403. Upon the Internet user entering her mailbox number, the IWS queries the field AD MAILBOX NUMBER in the Ad Database to determine if the mailbox number is valid 2404. If the mailbox number is invalid, the Internet user is presented with an Invalid Mailbox Number Form 2405.

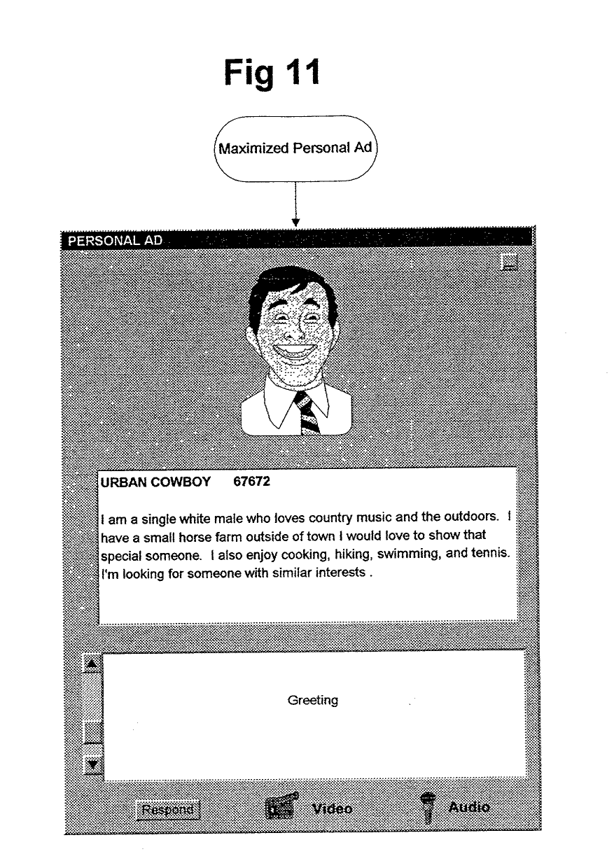

If the mailbox number is valid, the IWS presents the Internet user with a Results Form 2406. The Results Form 2406 shows the ad the Internet user selected. Specifically, the Results Form shows the twenty word text ad that appears in the newspaper 2407. In addition, the ad contains one or more icons that represent any additional text or multimedia files (audio, video, photograph) for the ads that are available on the IWS. These icons include an audio icon 2408 to denote the ad's audio greeting, a still camera icon 2409 to denote a photograph of the advertiser, a video camera icon 2410 to denote a video clip of the advertiser, or a paper icon 2411 to denote the ad's full text greeting, if the ad was placed on the Internet. It is to be understood that these icons are merely representative and that many other possibilities exist to denote the existence of text and multimedia files. By clicking on an icon, the Internet user can view or listen to the associated file. In addition, by selecting a maximize bar 2412, the Internet user can expand an ad to full page size FIG. 11. The Internet user responds to an ad by selecting the “Respond” button 2413.

When the Internet user selects the respond button, she is presented with an Ad Response Form 2414. The Internet user creates a response by completing a response text field 2416. After completing the Ad Response Form, the Internet user submits the form by pressing the “Submit” button 2422. The advertiser is then presented with a Response Confirmation Form 2423. The Response Confirmation Form gives the advertiser information on enhancing her response with an audio message, photograph, or video clip.

The IWS then stores the response to a disk file and updates the Ad Database 2424. Specifically, the IWS creates a new record in the AD_RESPONSE_TABLE FIG. 4 and populates the fields RSP_MAILBOX_NUMBER 501, RSP_DATE_TIME 503, RSP_TYPE 504, and RSP_FILENAME 505 to indicate the mailbox number of the ad responded to, the date and time of the response, the format of the response, and the location of the response file on the IWS. The field RSP_TYPE 504 is set to TEXT. Finally, the field RSP_CONVERSION_FLAG 506 is set to TRUE to indicate that the text does not need to be converted to a different format.

Enhancing a Response with Audio, Photograph and Video

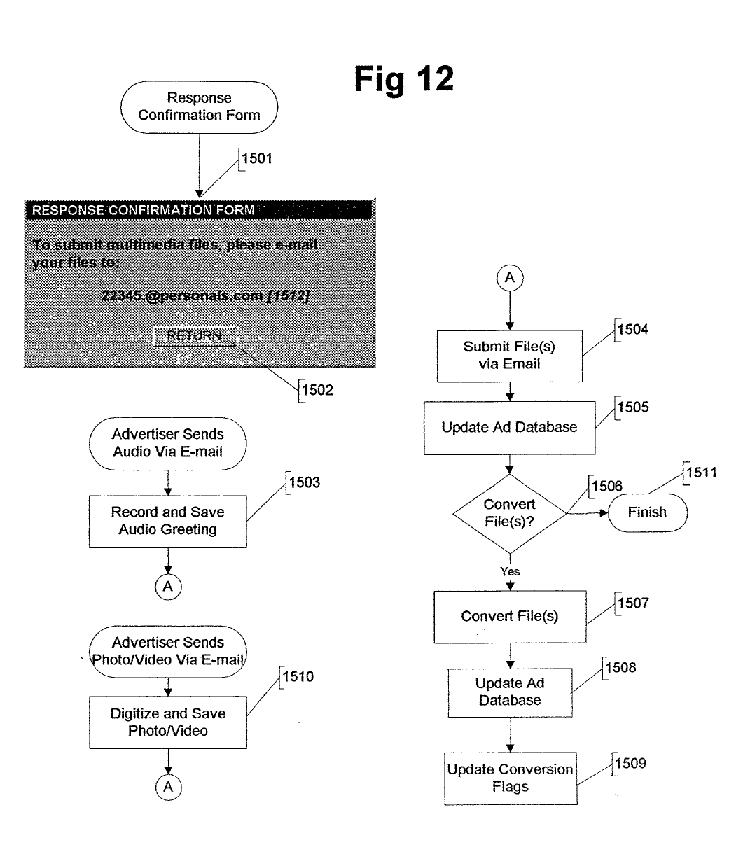

As already indicated, after a text response has been submitted via the Internet, the Internet user is shown a Response Confirmation Form FIG. 12 1501. The response confirmation form gives the Internet user instructions on how to enhance a response to an ad with audio, video, or a photograph.

A more detailed explanation of how a respondent submits an audio response, photograph, or video clip via CT1 will now be given. To submit an audio response, the Internet user first makes an audio recording using a WAV file editor and then saves the file using her five digit mailbox number as the file name 1503, for example: 44567.wav. The Internet user then submits the audio file using e-mail to the recipient's electronic mailbox on the IWS 1504, for example: 22345@personals.com 1512. The Internet user's audio response is stored to a disk file on the IWS and the Ad Database is updated 1505.

Specifically, the IVR creates a new record in the AD_RESPONSE_TABLE FIG. 4 and populates the fields RSP_MAILBOX_NUMBER 501, RSP_DATE_TIME 503, RSP_TYPE 504, and RSP_FILENAME 506 to indicate the mailbox number of the ad responded to, the date of the response, the format of the audio file, and the location of the audio file on the IVR. The field RSP_TYPE 504 is set to WAV to indicate that the audio recording is in the Microsoft .WAV file format. Also, the field RSP_CONVERSION_FLAG 506 is set to FALSE to indicate that the audio file must be converted from the Microsoft .WAV format to create two new audio response files: one in the RealAudio .RA format for playback on the Internet, and another in the Dialogic .VOX format for playback via the telephone.

The IWS determines if conversion of audio files is needed 1506, and then creates a new RealAudio .RA file and Dialogic .VOX file from the Microsoft .WAV file 1507. The RealAudio file is stored on the IWS and the Dialogic file is stored on the IVR. The IWS also updates the Ad Database 1508. Specifically, for each new audio file, the IWS creates a new record in the AD RESPONSE_TABLE FIG. 4 and populates the fields RSP_MAILBOX_NUMBER 501, RSP_DATE_TIME 503, RSP_TYPE 504, and RSP_FILENAME 505 to indicate the mailbox number of the ad responded to, the date of the response, the format of the response, and the location of the response file on the IWS. Finally, the field RSP_CONVERSION_FLAG 506 is set to TRUE for both the source audio file (.WAV) and the target audio files (.VOX and .RA) to indicate that the audio files do not need to be converted 1509.

To send a photograph in response to an ad, the Internet user first digitizes a photograph using a scanner or takes a photograph with a digital camera and then saves the image to a .GIF file using her five digit mailbox number as the file name 1510, for example: 44567.gif. The respondent then submits the graphic file using e-mail to the recipient's electronic mailbox, for example: 22345@personals.com 1504. The respondent's photo is stored to a disk file on the IWS and the Ad Database is updated 1505.

Specifically, the IWS creates a new record in the AD_RESPONSE_TABLE FIG. 4 and populates the RSP_MAILBOX_NUMBER 501, RSP_DATE_TIME 503, RSP_TYPE 504, and RSP_FILENAME 505 to indicate the mailbox number of the ad responded to, the date of the response, the file format of the photograph, and the location of the file on the IWS. The field RSP_TYPE 504 is set to GIF to indicate that the graphic file is in the .GIF file format. Finally, the field RSP CONVERSION_FLAG 506 is set to TRUE to indicate that no file conversion is necessary as .GIF is the graphic file format used by the IWS 1506. It should be noted that file conversion may or may not be necessary depending on what file formats are supported by the IWS and IVR and in what formats the system allows users to submit files.

To send an advertiser a video clip, the Internet user first digitizes a video clip and then saves the image to a Microsoft .AVI file using her five digit mailbox number as the file name 1510, for example: 44567.avi. Other video formats such as Apple Quicktime, or MPEG video could also be used. The respondent then submits the graphic file using e-mail to the recipient's electronic mailbox, for example: 22345@personals.com 1504. The respondent's video is stored to a disk file on the IWS and the Add Database is updated 1505.

Specifically, the IVR creates a new record in the AD_RESPONSE_TABLE FIG. 4 and populates the fields RSP_MAILBOX_NUMBER 501, RSP_DATE_TIME 503, RSP TYPE 504, and RSP_FILENAME 505 to indicate the mailbox number of the ad responded to, the date of the response, the file format of the video clip, and the location of the video file on the IWS. Specifically, the field RSP_TYPE 504 is set to AVI to indicate that the audio recording is in the Microsoft .AVI file format. Finally, the field RSP CONVERSION_FLAG 506 is set to FALSE to indicate that the VDOLive file must be converted to the VDOLive format for real time playback on the Internet.

The IWS determines that the video file must be converted to VDOLive format 1506. The IWS creates a new VDOLive file from the Microsoft .AVI file and stores the new file to a disk file 1507 on the IWS and updates the Ad Database 1508. A new record in the AD_RESPONSE_TABLE FIG. 4 is created and the IWS populates the RSP_MAILBOX_NUMBER 501, RSP_DATE_TIME 503, RSP_TYPE 504, and RSP_FILENAME 505 fields to indicate the mailbox number of the ad responded to, the date and time of the response, the format of the video file, and the location of the video file on the IWS. Finally, the field RSP_CONVERSION_FLAG 506 is set to TRUE for both record formats (AVI and VDOLive) in the Ad Database to indicate that the video file(s) does not need to be converted 1509.

Retrieving Responses Through a TELEPHONE

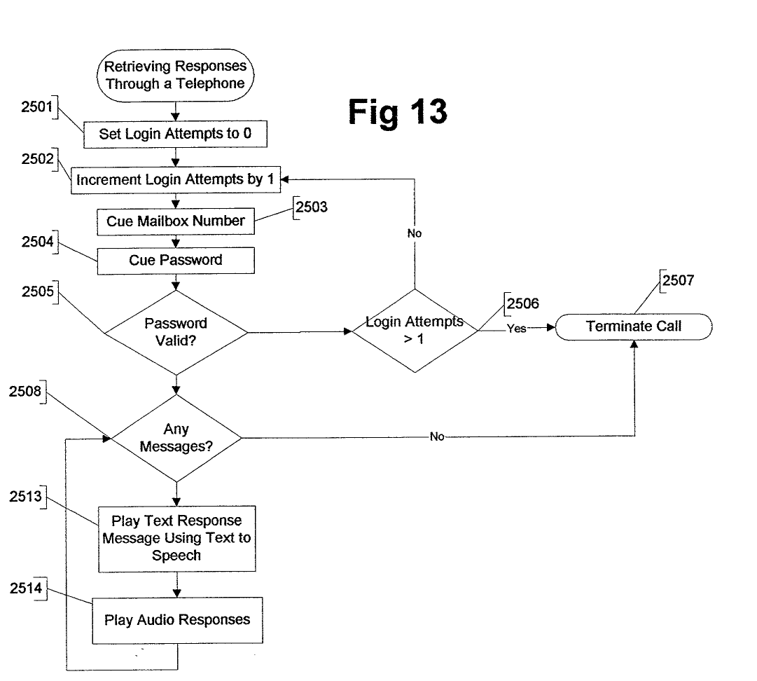

An exemplary operation of the system, with regard to an advertiser retrieving responses to his personal ad will now be treated to accomplish the process as indicated in FIG. 13. First, suppose an advertiser at terminal T1 places a call to retrieve messages left in response to his ad. The assumed call involves the advertiser actuating the buttons to input the number 1-9-0-0-7-7-7-4-4-4-4, for example. As a result, signals are provided to the PTN resulting in a connection from the remote terminal T1 to the IVR. Using standard DNIS techniques, the IVR associates the called number 1-9-0-0-7-7-7-4-4-4-4 with a specific format, for example, a message retrieval format.

Referring to FIG. 13, upon receiving a call, the IVR sets the “logon attempts” equal to zero 2501. The IVR then increments the “logon attempts” by one 2502 and cues the caller for a mailbox number 2503 and password 2504. The IVR then queries the Ad Database to determine if the mailbox number and password are valid 2505. If the entries are not valid, the IVR determines if the caller has exceeded the maximum number of logon attempts allowed 2506. If the caller has exceeded the maximum number of logon attempts allowed, the call is terminated 2507. If the maximum number of logon attempts allowed has not been exceeded, the IVR increments the “logon attempts” by one 2502 and again cues the caller for a mailbox number 2503 and password 2504.

If the entries are valid, the IVR then queries the AD_RESPONSE_TABLE FIG. 4 to determine if the advertiser has any response messages 2508. If the advertiser has no response messages, the call is terminated 2507. If the IVR finds a response, the IVR plays the text 2513 and audio 2514 messages from the respondent. If a response is in text form, the IVR uses text to speech to play the message. If there are additional responses, the caller is returned to block 2513. Otherwise, the call is terminated 2507.

Retrieving Messages Through the Internet

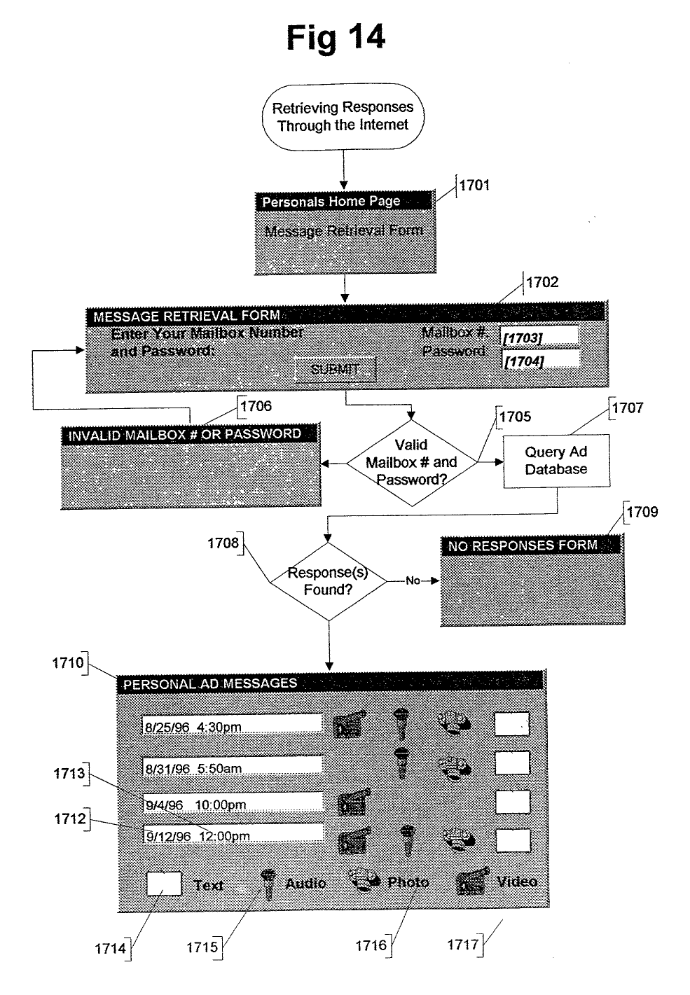

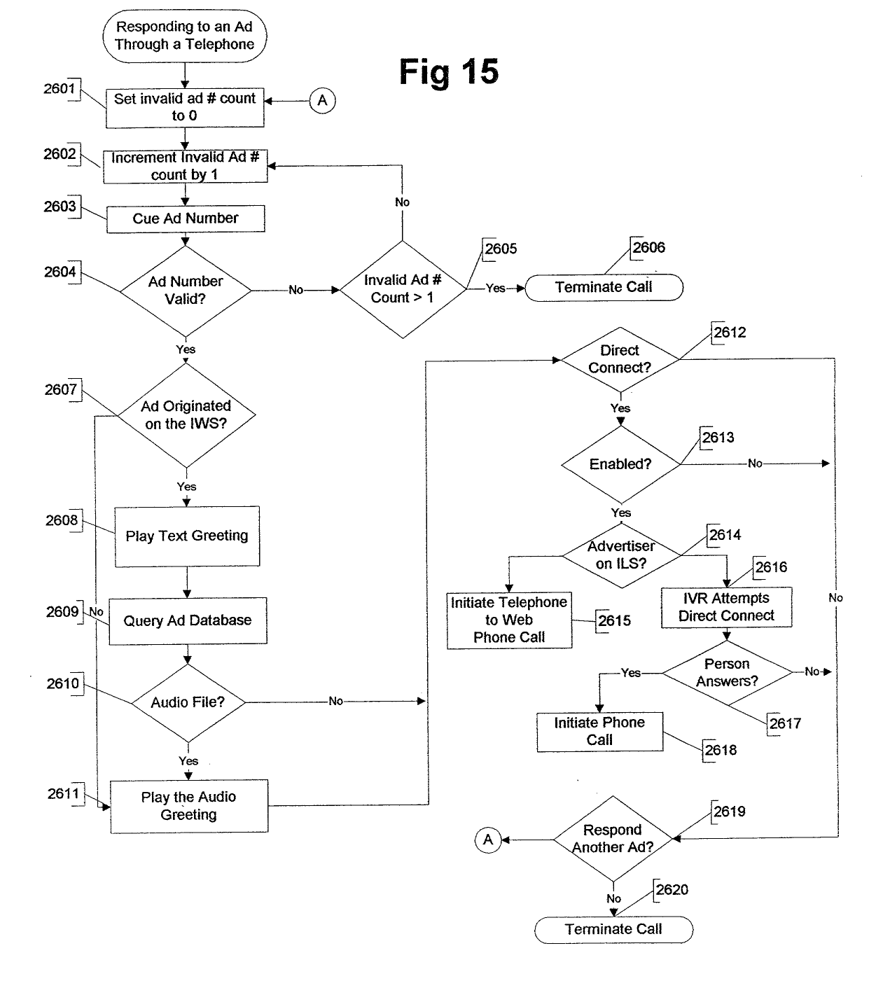

An exemplary operation of the system, with regard to an advertiser retrieving her messages via the Internet will now be treated to accomplish the process as indicated in FIG. 14. First, suppose an advertiser at terminal CT1 connects to the Internet to retrieve messages. The assumed Internet user connects to the Internet and inputs a Uniform Reference Locator (URL), for example: http://www.personal_ads.com, resulting in a connection from the remote terminal CT1 to a Home Page 1701 on the IWS.

Referring to FIG. 14, from the Home Page 1701 on the IWS, the advertiser selects a Message Retrieval Form 1702. The Message Retrieval Form 1702 instructs the advertiser to enter a mailbox number 1703 and password 1704. The IWS then queries the Ad Database to determine if the mailbox number and password are valid 1705. If the entries are not valid, the Internet user is presented with an Invalid Mailbox and Password Form 1706. If the entries are valid 1705, the IWS queries the Ad Database 1707 to find responses to the advertiser's ad.

If there are no responses, the IWS presents the advertiser with a No Responses Form 1709. If the IWS finds one or more responses, the IWS presents the advertiser with a Personal Ad Messages Form 1710. The Personal Ad Messages Form 1709 shows any messages for the advertiser. Each message shows the date 1712 and time 1713 the message was received and contains one or more icons that represent the contents of the message. A text icon 1714 denotes a text message; an audio icon 1715 denotes an audio message; a still camera icon 1716 denotes a photograph; a video camera icon 1717 denotes a video clip. By clicking on an icon, the advertiser can view or listen to the associated file.

Initiating Direct Connect Through a Telephone

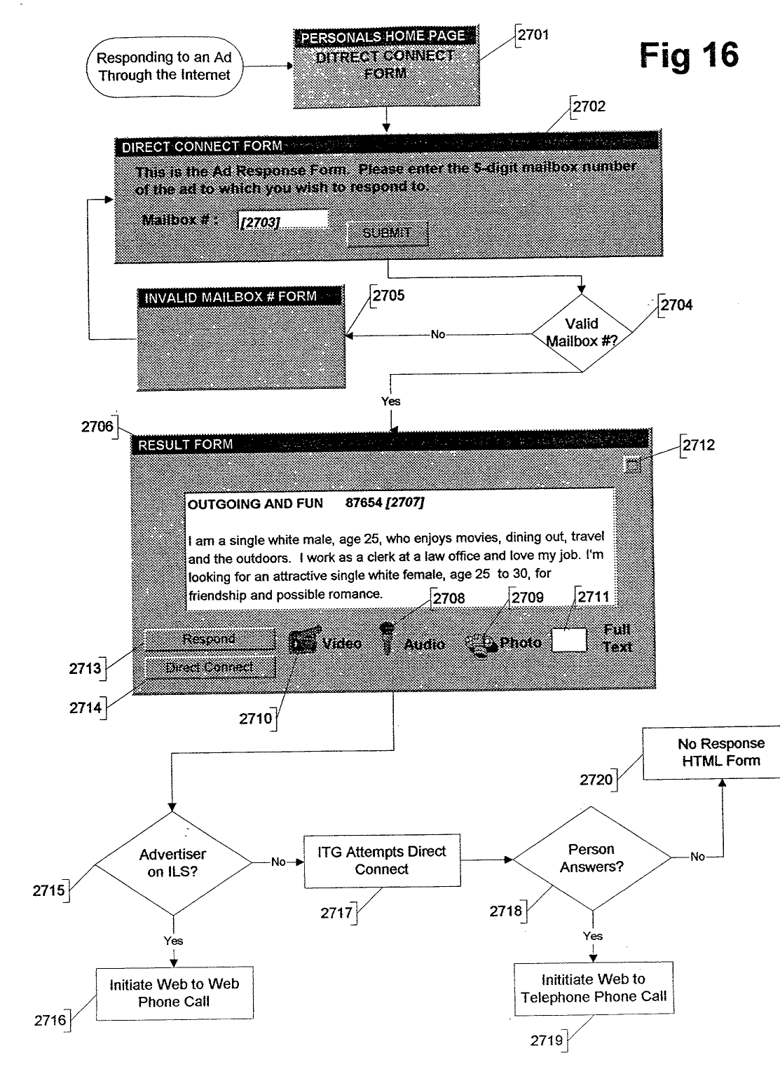

An exemplary operation of the system, with regard to a telephone caller responding to a personal advertisement by using the Direct Connect feature to speak with an advertiser will now be treated to accomplish the process as indicated in FIG. 15. First, suppose a telephone caller at terminal T1 places a call to respond to a personal ad advertised in XYZ newspaper. The assumed call involves the telephone caller actuating the buttons to input the number 1-9-0-0-7-7-7-3-3-3-3, for example. As a result, signals are provided to the PTN resulting in a connection from the remote terminal Tl to the IVR. Using standard DNIS techniques, the IVR associates the called number 1-9-0-0-7-7-3-3-3-3 with a specific format, for example, a voice personals response format.

Referring to FIG. 15, upon receiving a call, the IVR sets the “invalid mailbox number count” equal to zero 2601. The IVR then increments the “invalid mailbox number count” by one 2602 and cues the caller for a mailbox number 2603. Upon the caller entering a mailbox number, the IVR queries the field AD_MAILBOX_NUMBER 201 to determine if the mailbox number is valid 2604. If the mailbox number is invalid, the IVR determines if the caller has exceeded the maximum number of attempts allowed 2605. If the caller has exceeded the maximum number of attempts allowed, the call is terminated 2606. If the maximum number of attempts allowed has not been exceeded, the IVR increments the “invalid mailbox number count” by one 2602 and again cues the caller for a mailbox number 2603.

If the mailbox number is valid, the IVR queries the field AD_ORIGIN 211 to determine if the ad originated on the Internet 2607. If the ad originated on the telephone, the IVR plays the ad's audio greeting 2611. If the ad originated on the Internet, the IVR uses text to speech to play the ad's text greeting as placed on the Internet 2608. The IVR then queries the AD_GREETINGS_TABLE FIG. 2 to determine if the Internet advertiser also submitted an audio greeting 2609. If the query does not find an audio greeting 2610, the IVR prompts the caller to indicate if he wishes to direct connect to the advertiser 2612. If the query finds an audio greeting 2610, the IVR plays the audio greeting 2611. The IVR then prompts the caller to indicate if he wishes to direct connect to the advertiser 2612.

If the caller elects not to direct connect to the advertiser, he is then prompted to respond to another ad 2619. If the caller chooses to respond to another ad, the IVR continues processing at block 2601, otherwise the call is terminated 2620. If the caller elects to direct connect to the advertiser, the IVR instructs the caller to hold while a call is attempted. The IVR first queries the Ad Database to determine if the advertiser has enabled the direct connect feature 2613. If the advertiser has not enabled the direct connect feature, the caller is so notified and the caller is given the option to respond to another ad 2619. It may be desirable to publish an icon in the newspaper in each ad that indicates if the direct connect feature is enabled so a respondent knows ahead of time if this option is available. If the advertiser has enabled direct connect, the IVR queries the ILS to determine if the advertiser is currently available on the Internet 2614. If the advertiser is registered with the Internet Locator Service (ILS), the Internet/Telephone Gateway (ITG) initiates an TCP/IP-based Internet telephone call with the advertiser. If the advertiser accepts the Internet telephone call, the ITG bridges the call from the IVR to the advertiser and a conversation ensues 2615.

If the advertiser is not registered with the ILS, the IVR retrieves the advertiser's telephone number from the Ad Database and attempts to call the advertiser 2616. If a busy signal or answering machine are encountered, the call is aborted and the IVR notifies the caller that the call can not be completed at that time. The caller is then given the option to respond to another ad or to terminate the call 2619. If the IVR's call is answered by a person, the IVR bridges the call between the respondent and the advertiser and a conversation ensues 2617. It may be desirable to allow the person who answers to indicate if he wishes to accept the call. For example, “This is the personal ad service. There is a respondent to your ad who wishes to speak with you. To accept this call, press 1. To reject this call, press 2.” If the person who answers the phone rejects the call, the caller could then be given the option to respond to another ad or to terminate the call.

Initiating Direct Connect Through the Internet

An exemplary operation of the system, with regard to a specific Internet user responding to a personal ad via the Internet by using the direct connect feature will now be treated to accomplish the process as indicated in FIG. 16. First, suppose an advertiser at terminal CT1 connects to the Internet to respond to a personal advertisement advertised in XYZ newspaper. The assumed Internet user connects to the Internet and inputs a URL, for example: http://www.personal_ads.com, resulting in a connection from the remote terminal CT1 to a Home Page on the IWS.

Referring to FIG. 10, from the Home Page 2701 on the IWS, the Internet user selects a Direct Connect Form 2702. The Ad Response Form instructs the Internet user to enter the five digit mailbox number of the ad she wishes to respond to 2703. Upon the Internet user entering her mailbox number, the IWS queries the field AD_MAILBOX_NUMBER in the Ad Database to determine if the mailbox number is valid 2704. If the mailbox number is invalid, the Internet user is presented with an Invalid Mailbox Number Form 2705.

If the mailbox number is valid, the IWS presents the Internet user with a Results Form 270. The Results Form 2706 shows the ad which the Internet user selected. Specifically, the Results Form shows the twenty word text ad that appears in the newspaper 2707. In addition, the ad contains one or more icons that represent any additional text or multimedia files (e.g., audio, video, photograph, etc.) for the ads that are available on the IWS. These icons include an audio icon 2708 to denote the ad's audio greeting, a still camera icon 2709 to denote a photograph of the advertiser, a video camera icon 2710 to denote a video clip of the advertiser, or a paper icon 2711 to denote the ad's full text greeting, if the ad was placed on the Internet. It is to be understood that these icons are merely representative and that many other possibilities exist to denote the existence of additional text and multimedia files. By clicking on an icon, the Internet user can view or listen to the associated file. In addition, by selecting a maximize bar 2712, the Internet user can expand an ad to full page size FIG. 11.

The Internet user responds to an ad by selecting the “Respond” button 2413 as described above. If the advertiser has enabled the direct connect option, the Internet user is also presented with a “Direct Connect” button 2714. The Internet user initiates a telephone call to the advertisers by selecting the “Direct Connect” button 2414. To use the direct connect feature the Internet user must have Internet telephony software or an Internet telephony enabled browser. Additionally, it may be desirable to charge the Internet user a fee for using the Direct Connect feature.

If the Internet user selects the “Direct Connect” button, the IWS first queries the ILS to determine if the advertiser is currently available on the Internet 2715. If the advertiser is registered with the ILS, the IWS initiates an TCP/IP-based Internet telephone call with the advertiser. If the advertiser accepts the Internet telephone call, the IWS launches the Internet users'Internet telephony software and a conversation ensues 2716. If both the Internet user and the advertiser have software that supports video, such as Microsoft NetMeeting 2.0, and computers equipped with a video capture card and a camera, they can also initiate a video conference.

If the advertiser is not registered with the ILS, the ITG retrieves the advertiser's telephone number from the Ad Database and attempts to call the advertiser 2717. If a busy signal or answering machine is encountered, the call is aborted and the IWS notifies the caller that the call cannot be completed at this time 2720. If the ITG's call is answered by a person, the respondent'Internet telephony software is launched, the two parties are bridged together, and a conversation ensues. As indicated above, it may be desirable in certain instances to prompt the person who answers the phone to indicate if he or she wishes to accept the call. For example, “This is the personal ad service. There is a respondent to your ad who wishes to speak with you. To accept this call, press 1. To reject this call, press 2.” If the person who answers the phone rejects the call, the IWS notifies the respondent, and provides the caller with another option, for example to end the call, to view another ad, or to respond to another ad.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

What is claimed is:

1. A method for storing an audio file, listening to said audio file via the Internet, and connecting the listener of said audio file with the storer of said audio file, said method comprising:
means for queuing the audio input of data into said audio file;
means for storing said audio file in digital memory;
means for transferring said audio file to an Internet access node;
means for controlling said transfer; and
means for connecting said listener to said storer;
wherein said means for transferring said audio file formats said audio message for output into humanly perceivable form; and
wherein said means for connecting said listener to said storer directly dials said storer's phone number and bridges said listener with said storer.

2. An apparatus for storing audio files, transferring said audio files to the Internet, listening to said audio file via the Internet, and connecting a caller with the storer of said audio file, said apparatus comprising:
an input queue;
a digital information storage device;
a transfer means;
an Internet access node;
a listening means; and
direct dial means;
wherein said digital information storage device stores phonemes indicative of audio, wherein said transfer means formats said digital information for output in humanly perceivable form via said Internet access node, wherein said listening means allows said caller to listen to said audio file, and wherein said direct dial means directly dials said storer's phone number and bridges said caller with said storer.
